(19) United States
(12) Patent Application Publication
(10) Pub. No.: US 2026/0307264 A1
(43) Pub. Date: Oct. 8, 2026

(54) GLOBAL LOCALIZATION APPARATUS AND METHOD THEREOF

(71) Applicants: Hyundai Motor Company, Seoul (KR); Kia Corporation, Seoul (KR)

(72) Inventors: Changyo LEE, Hwaseong-si (KR); Seungwon Song, Hwaseong-si (KR)

(21) Appl. No.: 19/365,029

(22) Filed: Oct. 21, 2025

Related U.S. Application Data
(63) Continuation-in-part of application No. 19/098,058, filed on Apr. 2, 2025.

(30) Foreign Application Priority Data
Oct. 17, 2024 (KR) 10-2024-0142400
Aug. 19, 2025 (KR) 10-2025-0115327

(51) Int. Cl. B25J 9/16; G06T 3/4007; G06T 7/70; G06V 10/762; G06V 10/77; G06V 10/80; G06V 20/70

(52) U.S. Cl. CPC B25J 9/1697; G06T 3/4007; G06T 7/70; G06V 10/762; G06V 10/7715; G06V 10/806; G06V 20/70

(57) ABSTRACT

In an embodiment a method includes generating, by a processor of a computing device, information for a plurality of keyframes, based on a plurality of image data obtained by using a camera mounted on a robot and robot pose data with respect to a position and orientation of the robot corresponding to each of the plurality of image data, determining, by the processor using at least one artificial intelligence module, place recognition information that identify a space with respect to each of the plurality of image data and managing, by the processor, an image gallery for supporting autonomous driving of the robot by clustering, based on the place recognition information, the plurality of keyframes into at least one group.

### CROSS-REFERENCE TO RELATED APPLICATIONS

This application is a Continuation-in-Part application of U.S. application Ser. No. 19/098,058, filed Apr. 2, 2025, which claims priority to and the benefit of Korean Patent Application No. 10-2024-0142400, filed Oct. 17, 2024, and further claims priority to and the benefit of Korean Patent Application No. 10-2025-0115327 filed with the Korean Intellectual Property Office on Aug. 19, 2025, and which applications are incorporated herein by reference in their entireties.

### TECHNICAL FIELD

The present disclosure relates to a method and apparatus for supporting autonomous driving of a robot by using an image gallery.

### BACKGROUND

Demand for autonomous driving technology for mobile robots in indoor and outdoor environments is increasing. At this time, navigation functions that locate and move to specific places according to user commands are becoming an essential element in various application fields such as logistics warehouses, factories, and service robots in buildings.

In order to perform these functions, the robot must be able to recognize its current location and surroundings, and autonomously determine and move along the optimal path to a given destination.

Conventionally, in order to implement such autonomous driving technology, methods were mainly used that relied on high-performance computing resources and expensive 3D sensors (e.g., RGB-D cameras), or processed complex computations externally through cloud computing based on the vision-language model (VLM).

However, this approach is computationally intensive and relies heavily on external network infrastructure, making it practically difficult to apply to low-spec mobile robots with limited computational power and battery capacity.

Full autonomous driving may not be possible in low-spec mobile robots and often relies on multiple human interventions. This not only causes high labor and operating costs, but also reduces the efficiency of the entire system.

Accordingly, there is a need for the development of mobile robot technology capable of autonomous driving without expensive equipment or external computing resources.

### SUMMARY

Embodiments provide a method that manages feature information structured in keyframe units in an image gallery format by utilizing the place recognition information determined through a (n lightweight) artificial intelligence module so that autonomous driving can be stably implemented based on place recognition even in low-spec mobile robot environments with limited computing resources.

Embodiments provide a method for efficiently supporting autonomous driving of the mobile robot without complex path-finding or high-precision maps, by enabling intuitive search and position mapping through a keyframe-based image gallery in response to the user's destination request.

Technical improvements desired to be achieved in the present disclosure are not limited to the aforementioned improvements, and other technical improvements not described above will be apparent to those skilled in the art from the disclosure of the present disclosure.

A method for supporting autonomous driving of the mobile robot, which is performed by a computing device including a processor and a memory, may include generating information on a plurality of keyframes, based on a plurality of image data obtained by using a camera mounted on the mobile robot and robot pose data with respect to a position and orientation of the mobile robot corresponding to each of the plurality of image data, by the processor, determining a place recognition information that identifies a space with respect to each of the plurality of image data, by using at least one artificial intelligence module, by the processor, and managing the image gallery for supporting autonomous driving of the mobile robot, by clustering the plurality of keyframes into at least one group, based on the place recognition information, by the processor.

Generating information for the plurality of keyframes may include estimating the robot pose data of each of the time points at which the plurality of image data are obtained, by using linear interpolation for compensating differences between time points at which the plurality of image data are obtained and a time point at which the robot pose data is obtained, by the processor.

Generating information for the plurality of keyframes may include determining image pose data with respect to a position and orientation of the camera corresponding to each of the plurality of image data, by using the robot pose data and external parameter of the camera, by the processor, and generating information for the plurality of keyframes, by using the plurality of image data and the image pose data, by the processor.

Determining the place recognition information may include extracting a shared feature vector from each of the plurality of image data, by using a lightweight shared feature extractor, by the processor.

Determining the place recognition information may include extracting a place feature vector with respect to a space included in each of the plurality of image data, by inputting the shared feature vector into a place recognition module, by the processor, and extracting a semantic feature vector with respect to an object included in each of the plurality of image data, by inputting the shared feature vector into a semantic segmentation module, by the processor.

Determining the place recognition information may include determining a fused feature vector with respect to the place feature vector and the semantic feature vector, by inputting the place feature vector and the semantic feature vector into an attention module, by the processor, and determining the place recognition information from the fused feature vector, by the processor.

Managing the image gallery may include determining a plurality of keyframe vectors by fusing a place feature vector corresponding to each of the plurality of image data and image pose data corresponding to each of the plurality of image data, by the processor, and clustering the plurality of keyframes into at least one group, based on a similarity between the plurality of keyframe vectors, by the processor.

Clustering the plurality of keyframes into at least one group may further include assigning a place label determined by using the place recognition information to the at least one group, by the processor.

The method may further include providing a plurality of candidate keyframes corresponding to the search word in the image gallery to the user, in response to receiving a search word with respect to a destination from a user, by the processor, and providing position information corresponding to a target keyframe determined based on a selection of the user, among the plurality of candidate keyframes, to the mobile robot, by the processor.

Providing the plurality of candidate keyframes corresponding to the search word in the image gallery to the user may include providing a web-based user interface that displays the plurality of candidate keyframes for each of the clustered at least one group, by the processor.

An apparatus for supporting autonomous driving of the mobile robot may include one or more non-transitory computer-readable media including an instruction, and one or more processors configured to perform an operation by executing the instruction, where the operation may include generating information on a plurality of keyframes, based on a plurality of image data obtained by using a camera mounted on a mobile robot and robot pose data with respect to position and orientation of the mobile robot corresponding to each of the plurality of image data, determining a place recognition information that identifies a space with respect to each of the plurality of image data, by using at least one artificial intelligence module, and managing a image gallery for supporting autonomous driving of the mobile robot, by clustering the plurality of keyframes into at least one group, based on the place recognition information.

The generation of information for the plurality of keyframes may include estimating the robot pose data of each of the time points at which the plurality of image data are obtained, by using linear interpolation for compensating differences between time points at which the plurality of image data are obtained and a time point at which the robot pose data is obtained.

The generation of information for the plurality of keyframes may include determining image pose data with respect to position and orientation of the camera corresponding to each of the plurality of image data, by using the robot pose data and external parameter of the camera, and generating information for the plurality of keyframes, by using the plurality of image data and the image pose data.

The determination of the place recognition information may include extracting a shared feature vector from each of the plurality of image data, by using a lightweight shared feature extractor.

The determination of the place recognition information may include extracting a place feature vector with respect to a space included in each of the plurality of image data, by inputting the shared feature vector into a place recognition module, and extracting a semantic feature vector with respect to an object included in each of the plurality of image data, by inputting the shared feature vector into a semantic segmentation module.

The determination of the place recognition information may include determining a fused feature vector with respect to the place feature vector and the semantic feature vector, by inputting the place feature vector and the semantic feature vector into an attention module, and determining the place recognition information from the fused feature vector.

The managing of the gallery may include determining a plurality of keyframe vectors by fusing a place feature vector corresponding to each of the plurality of image data and image pose data corresponding to each of the plurality of image data, and clustering the plurality of keyframes into at least one group, based on a similarity between the plurality of keyframe vectors.

The clustering of the plurality of keyframes into at least one group may further include assigning a place label determined by using the place recognition information to the at least one group.

The operation may further include providing a plurality of candidate keyframes corresponding to the search word in the image gallery to the user, in response to receiving a search word with respect to a destination from a user, and providing position information corresponding to a target keyframe determined based on a selection of the user, among the plurality of candidate keyframes, to the mobile robot.

One or more non-transitory computer-readable media including an instruction executable by a computing device is provided where the instruction causes the computing device to perform an operation when executed by one or more processors of the computing device, and where the operation may include generating information on a plurality of keyframes, based on a plurality of image data obtained by using a camera mounted on a mobile robot and robot pose data with respect to position and orientation of the mobile robot corresponding to each of the plurality of image data, determining a place recognition information that identifies a space with respect to each of the plurality of image data, by using at least one artificial intelligence module, and managing the image gallery for supporting autonomous driving of the mobile robot, by clustering the plurality of keyframes into at least one group, based on the place recognition information.

According to an embodiment, without a high-performance GPU or 3D sensor, the autonomous driving of the mobile robot having a limited computing resource may be stably supported, by establishing and managing the image gallery by using camera-based 2D image data and robot pose data.

In addition, according to an embodiment, by extracting spatial features and semantic features in parallel by using the place recognition module and the semantic segmentation module, and generating robust place recognition information through attention-based fusion, accurate position estimation and destination determination can be available even in various environments.

In addition, according to an embodiment, by clustering a plurality of keyframes into at least one group, based on a similarity between keyframe vectors, and assigning a place label to each group, it is possible to construct the image gallery based on visual information similar to an actual environment, and to improve the search efficiency.

### BRIEF DESCRIPTION OF THE DRAWINGS

FIG. 1 is a block diagram for explaining an apparatus for supporting autonomous driving of a mobile robot according to an embodiment.

FIG. 2 is a flowchart for explaining a method for supporting autonomous driving of a mobile robot according to an embodiment.

FIG. 3 is a drawing for explaining a management system for supporting autonomous driving of a mobile robot according to an embodiment.

FIG. 4 is a drawing for explaining obtaining of a keyframe information according to an embodiment.

FIG. 5 is a drawing for explaining determining of place recognition information that identifies a space with respect to image data by using at least one artificial intelligence module according to an embodiment.

FIG. 6 is a drawing for explaining extracting of a place feature vector by using a lightweight shared feature extractor and a place recognition module according to an embodiment.

FIG. 7 is a drawing for explaining extracting of a semantic feature vector by using a lightweight shared feature extractor and a semantic segmentation module according to an embodiment.

FIG. 8 is a drawing for explaining determining of place recognition information by inputting a place feature vector and a semantic feature vector according to an embodiment into an attention module.

FIG. 9 is a drawing for explaining clustering of a plurality of keyframes into at least one group, based on a similarity between a plurality of keyframe vectors according to an embodiment.

FIG. 10 is a drawing for explaining providing of position information corresponding to a target keyframe to the mobile robot, based on a user's input with respect to a web-based user interface that displays a plurality of candidate keyframes according to an embodiment.

FIG. 11 is a drawing for explaining a computing device according to an embodiment.

### DETAILED DESCRIPTION OF ILLUSTRATIVE EMBODIMENTS

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software. Furthermore, at least some of the configurations or functions of a method and apparatus for supporting autonomous driving of a mobile robot according to the exemplary embodiments described below may be implemented as programs or software, and programs or software may be stored in computer-readable media.

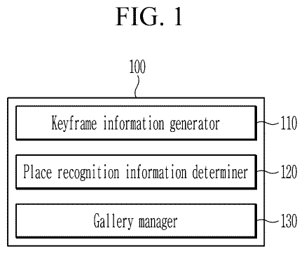

FIG. 1 is a block diagram for explaining an apparatus for supporting autonomous driving of a mobile robot according to an embodiment.

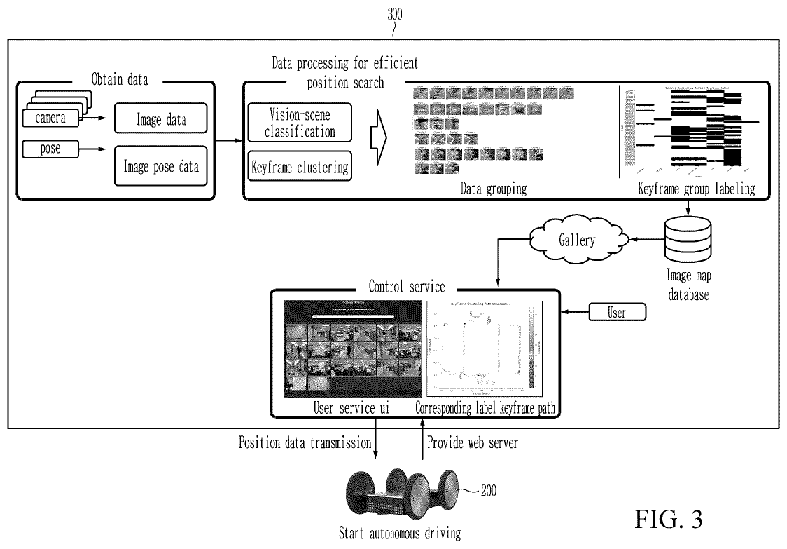

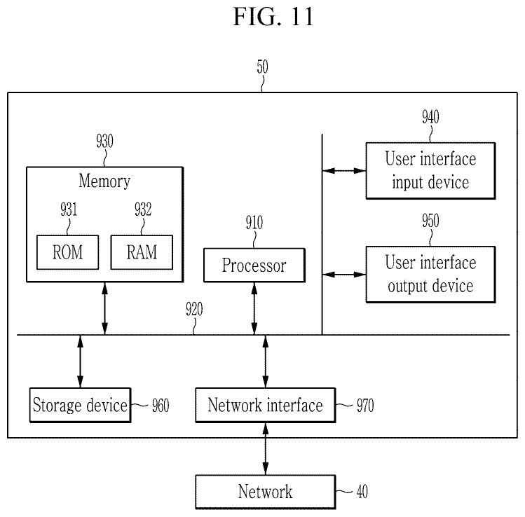

Referring to FIG. 1, an apparatus 100 for supporting autonomous driving of a mobile robot according to an embodiment may be implemented as a computing device that includes a processor and a memory. For example, the apparatus 100 for supporting autonomous driving of a mobile robot may be implemented as a computing device 50 described later with reference to FIG. 11. In this case, the processor may correspond to a processor 910 of the computing device 50, and the memory may correspond to a memory 930 of the computing device 50. Alternatively, in some embodiments, the apparatus 100 for supporting autonomous driving of a mobile robot may be implemented as an apparatus linked with a management system 300 illustrated in FIG. 3. Alternatively, in some embodiments, the apparatus 100 for supporting autonomous driving of a mobile robot may include one or more non-transitory computer-readable media including an instruction and one or more processors configured to perform an operation by executing the instruction. Here, the operation may include a configuration, a function, a step, etc. described in this specification with respect to a method and apparatus for supporting autonomous driving of a mobile robot according to embodiments. In in this specification, the term “module” is used in order to logically differentiate these operations performed by a method and apparatus for supporting autonomous driving of a mobile robot according to embodiments.

In the present disclosure, the mobile robot may mean a robot designed to perform the real-time autonomous driving function in the indoor or outdoor space, without the support of a high performance GPU or an external cloud computing resource.

In addition, in the present disclosure, the mobile robot is equipped with an image sensor, a processor, and a control module, and can recognize the environment based on a plurality of images and position data through a point of interest (POI), and autonomously set a path and move according to the user's destination request.

In addition, in the present disclosure, in response to the user request for destination, the POI system may perform a function of defining a target point for the mobile robot to move to as the point of interest (POI), and managing the point of interest by linking it with information within the keyframe-based image gallery.

In the present disclosure, the management system is a system that generates and manages an image gallery by generating information on keyframes based on images obtained from a plurality of mobile robots and position data, and clustering the keyframes based on a place recognition information derived through an artificial intelligence module, and may include a control server that controls the same.

In addition, in the present disclosure, the management system may support autonomous driving of a mobile robot, such as setting a target point or path of the mobile robot in response to a destination search request from the user.

In addition, in the present disclosure, the image gallery is a place-based database established and managed in order to support autonomous driving of a mobile robot, and may store all types of information obtained or determined through the mobile robot, the artificial intelligence module, and the control server.

The apparatus 100 for supporting autonomous driving of a mobile robot may include a keyframe information generator 110, the place recognition information determiner 120, and a gallery manager 130.

First, the keyframe information generator 110 may generate information on a plurality of keyframes, based on a plurality of image data obtained by using a camera mounted on the mobile robot and robot pose data with respect to a position and orientation of the mobile robot corresponding to each of the plurality of image data.

Here, the image data is data with respect to a 2-dimensional RGB image obtained through the camera mounted on the mobile robot, and may include visual information of surrounding environments of the robot.

In addition, the robot pose data is data representing the position and orientation of the robot obtained through a sensor (e.g., a GPS sensor, an IMS sensor, or the like) mounted on the mobile robot, and may include, for example, data in 6 degrees of freedom (DoF) representing (x, y, z, roll, pitch, yaw).

In addition, the information for the keyframe is information on an image (i.e., keyframe) including visual information and position information, and may mean information generated from image data obtained during driving of the mobile robot and the robot pose data at a time point at which the image data is obtained.

In some embodiments, the plurality of image data and the robot pose data corresponding to each of the plurality of image data may not be time synchronized, because they are obtained by using different sensors.

At this time, the keyframe information generator 110 may estimate the robot pose data of each of time points at which the plurality of image data are obtained, by using linear interpolation for compensating differences between time points at which the plurality of image data are obtained and a time point at which the robot pose data is obtained.

In more detail, the robot pose data estimated by using linear interpolation may be represented as the following Equation 1.

$$α = \frac{t - {t}_{- 1}}{{t}_{+ 1} - {t}_{- 1}} ( 0 \leq α \leq 1 ) \qquad ( Equation 1 )$$

$$image\_pose = ( 1 - α ) \cdot {robot\_pose}_{t - 1} + α \cdot {robot\_pose}_{t + 1}$$

here, α may represent a time-based interpolation coefficient, imageₚₒₛₑ may represent the robot pose data at an image photographing time point t estimated by using linear interpolation, and robot_poseₜ₋₁ and robot_poseₜ₊₁ may represent the robot pose data, at the time point t₋₁ before the image photographing and at the time point t₊₁ after the image photographing, respectively.

In addition, the keyframe information generator 110 may determine image pose data with respect to position and orientation based on the camera corresponding to each of the plurality of image data, by using the robot pose data and external parameter of the camera.

For example, with respect to the robot pose data representing the position and orientation in the mobile robot coordinate system, the keyframe information generator 110 may determine the image pose data, by mapping the position and orientation in the mobile robot coordinate system to a camera coordinate system by applying a rotation matrix and a translation vector defined as external parameters of the camera.

In addition, the keyframe information generator 110 may generate information for the plurality of keyframes, by using the plurality of image data and the image pose data.

On the other hand, the keyframe information generator 110 may store the plurality of image data and the robot pose data corresponding to each of the plurality of image data and the image pose data in the image gallery.

As such, in the present disclosure, keyframes in which visual information and position information are synchronized may be generated, without relying on a separate 3D sensor.

Subsequently, the place recognition information determiner 120 may determine the place recognition information that identifies a space with respect to each of the plurality of image data, by using at least one artificial intelligence module.

Here, the at least one artificial intelligence module may include a lightweight shared feature extractor, a place recognition module, a semantic segmentation module, and an attention module.

The lightweight shared feature extractor may mean a module that extracts visual features in the level that can be commonly utilized for place recognition and semantic analysis from each of the plurality of image data.

For example, the shared feature extractor may be implemented by using a lightweight convolutional neural network structure (e.g., MobileNet, EfficientNet, or the like) configured in consideration of computing efficiency.

The place recognition module may mean a module that receives a shared feature vector extracted from the lightweight shared feature extractor, and generates a place feature vector reflecting visual characteristics of a space where that image was photographed.

For example, the place recognition module may be implemented by using a pre-trained multi head transformer encoder. The place recognition module may determine the place feature vector corresponding to each image, based on a self-attention operation that reflects the mutual relationship between feature vectors extracted from the plurality of image data, and a cross-attention operation that reflects a mutual relationship with respect to a pre-learned reference vector.

Such a transformer-based place recognition module may provide a robust place recognition result in various environments and time point changes, and the accuracy and reliability of the image gallery for autonomous driving of the mobile robot may be improved.

The semantic segmentation module may mean a module that receives the shared feature vector extracted from the shared feature extractor, and determines semantic information for the object or structure included in that image.

For example, the semantic segmentation module may be implemented by using a semantic classification layer (e.g., DeepLabV3 classification layer), in order to predict the class (or category) of the object with respect to each pixel within the image, or to analyze existence of the object and distribution characteristics thereof with respect to the entire image.

The attention module may mean a module that receives the place feature vector and a semantic feature vector and generates a fused feature vector based on the mutual importance between the two vectors.

On the other hand, the neural network structure of the at least one artificial intelligence module is merely an example, and may be variously modified within a range that can achieve the object of the present disclosure.

In more detail, the place recognition information determiner 120 may extract the shared feature vector representing the visual feature with respect to each of the plurality of image data, by using the lightweight shared feature extractor.

In more detail, the place recognition information determiner 120 may perform preprocessing with respect to the region of interest by inputting the plurality of image data into a region of interest (ROI) extractor, and may extract the shared feature vector from each of the preprocessed plurality of image data.

Through this, a meaningful region related to the autonomous driving of the mobile robot may be identified in each image, and pixel information included in the region may be extracted.

In addition, the place recognition information determiner 120 may extract the place feature vector with respect to a space included in each of the plurality of image data, by inputting the shared feature vector into the place recognition module.

In more detail, the place recognition information determiner 120 may strengthen context information of each shared feature vector, by performing self-attention for reflecting the mutual relationship between a plurality of shared feature vectors.

In addition, the place recognition information determiner 120 may extract the place feature vector suitable for the query vector, by performing intersection attention with the plurality of shared feature vectors, based on a pre-learned a query vector.

Here, the pre-learned the query vector may mean an embedding vector representing the type or feature of a specific place.

In addition, the place recognition information determiner 120 may extract the semantic feature vector with respect to the object included in each of the plurality of image data, by inputting the shared feature vector into the semantic segmentation module. Here, the semantic feature vector may mean a feature vector representing the meaning with respect to the object included in each of the plurality of image data.

In more detail, the place recognition information determiner 120 may extract the semantic feature vector, by classifying the class of objects in pixel units with respect to each of the plurality of input image data, and representing the type and distribution of the objects included in the entire image region or the region of interest in a vector format.

In addition, the place recognition information determiner 120 may determine the fused feature vector with respect to the place feature vector and the semantic feature vector, by inputting the place feature vector and the semantic feature vector into the attention module, and may determine the place recognition information from the fused feature vector.

In more detail, the place recognition information determiner 120 may determine the semantic feature vector reflecting the mutual relationship between a plurality of objects, by performing self-attention with respect to the semantic feature vector.

In addition, the place recognition information determiner 120 may determine the fused feature vector by inputting the place feature vector and the semantic feature vector reflecting the mutual relationship between the plurality of object into a fusion fully-connected layer.

In addition, the place recognition information determiner 120 may determine the place recognition information including the class with respect to the place, with reference to the probability or score calculated by inputting the fused feature vector into the classification layer.

On the other hand, the place recognition information determiner 120 may store the place feature vector, the semantic feature vector, the fused feature vector, and the place recognition information in the image gallery.

Subsequently, the gallery manager 130 may manage the image gallery for supporting autonomous driving of a mobile robot, by clustering the plurality of keyframes into at least one group, based on the place recognition information.

In more detail, the gallery manager 130 may determine a plurality of keyframe vectors by fusing the place feature vector corresponding to each of the plurality of image data and the image pose data corresponding to each of the plurality of image data.

In more detail, the gallery manager 130 may determine the keyframe vector, based on a concatenation operation with respect to the place feature vector and the image pose data.

In addition, the gallery manager 130 may cluster the plurality of keyframes into at least one group, based on a similarity between the plurality of keyframe vectors.

In more detail, the gallery manager 130 may perform clustering with respect to the plurality of keyframes corresponding to similar environments or places, by using a clustering algorithm that classifies the plurality of keyframes having a similar feature into at least one group based on similarity (or distance) between the plurality of keyframe vectors.

In some embodiments, the gallery manager 130 may use a density-based clustering algorithm (e.g., Hierarchical Density-Based Spatial Clustering of Applications with Noise (HDBSCAN) algorithm).

At this time, the gallery manager 130 can automatically form the clustering structure without setting the number of groups in advance, by hierarchically analyzing a relationship between the plurality of keyframes having different densities, and can improve the accuracy of clustering, by classifying keyframes with low density as noise.

On the other hand, the gallery manager 130 may assign a place label determined by using the place recognition information to at least one group.

Here, the place label according to an embodiment may mean an identifier representing at least one group.

In more detail, the gallery manager 130 may designate the class that the plurality of keyframes includes as the place label, and assign it to at least one clustered group.

For example, when the class that commonly corresponds to the plurality of keyframes included in a first group is ‘parking lot’, ‘park’, and ‘street’, the gallery manager 130 may determine the ‘parking lot’, ‘park’, and ‘street’ as the place label and assign it to the first group.

On the other hand, the gallery manager 130 may provide a plurality of candidate keyframes corresponding to the search word in the image gallery to the user, in response to receiving a search word with respect to the destination from the user.

In more detail, the gallery manager 130 may provide a web-based user interface that displays the plurality of candidate keyframes for each of the clustered at least one group, in response to receiving the search word with respect to the destination from the user.

For example, when ‘meeting room’ is input as the search word with respect to the destination, the gallery manager 130 may determine a second group for which ‘meeting room’ is assigned as the place label. Here, the gallery manager 130 may display the plurality of keyframes included in the second group to the user through the web-based user interface.

In addition, the gallery manager 130 may receive a user's input with respect to a target keyframe associated with the destination, among the plurality of candidate keyframes, and provide position information corresponding to the target keyframe to the mobile robot.

For example, the gallery manager 130 may provide the image pose data stored in the target keyframe to the mobile robot, in response to receiving selective input with respect to the target keyframe corresponding to the ‘meeting room’ desired by the user, among the plurality of keyframes included in the second group.

As such, in the present disclosure, even without a high performance GPU or 3D sensor, by establishing and managing the image gallery by using the camera-based 2D image data and the robot pose data, the autonomous driving of the mobile robot with limited computing resource may be stably supported.

In addition, in the present disclosure, by extracting spatial features and semantic features in parallel by using the place recognition module and the semantic segmentation module, and generating robust place recognition information through attention-based fusion, accurate position estimation and the destination determination is possible in various environments.

In addition, in the present disclosure, based on a similarity between keyframe vectors, by clustering the plurality of keyframes into at least one group, and assigning the place label to each group, the image gallery may be configured by using visual information similar to the actual environment, and at the same time, the search efficiency may be improved.

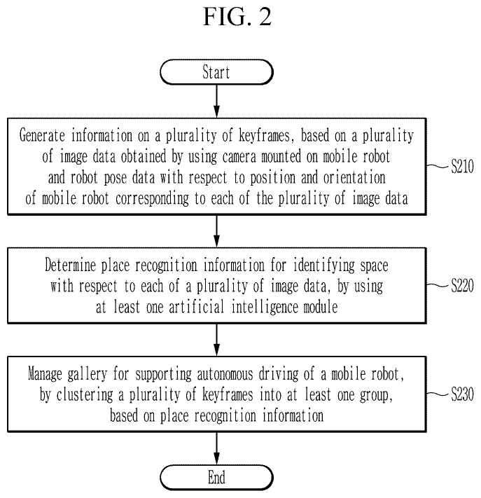

FIG. 2 is a flowchart for explaining a method for supporting autonomous driving of a mobile robot according to an embodiment.

Referring to FIG. 2, a method for supporting autonomous driving of a mobile robot according to an embodiment may include a step S210 of generating information for the plurality of keyframes, based on the plurality of image data obtained by using the camera mounted on the mobile robot and the robot pose data with respect to the position and orientation of the mobile robot corresponding to each of the plurality of image data, by the apparatus 100 for supporting autonomous driving of a mobile robot.

In addition, a method for supporting autonomous driving of a mobile robot according to an embodiment may include a step S220 of determining the place recognition information that identifies a space with respect to each of the plurality of image data, by using the at least one artificial intelligence module, by the apparatus 100 for supporting autonomous driving of a mobile robot.

In addition, a method for supporting autonomous driving of a mobile robot according to an embodiment may include a step S230 of managing the image gallery for supporting autonomous driving of a mobile robot, by clustering the plurality of keyframes into at least one group, based on the place recognition information, by the apparatus 100 for supporting autonomous driving of a mobile robot.

In some embodiments, the apparatus 100 for supporting autonomous driving of a mobile robot may provide the plurality of candidate keyframes corresponding to the search word in the image gallery to the user, in response to receiving the search word with respect to the destination from the user.

In addition, in some embodiments, the apparatus 100 for supporting autonomous driving of a mobile robot may receive a user's input with respect to the target keyframe associated with the destination, among the plurality of candidate keyframes, and provide position information corresponding to the target keyframe to the mobile robot.

FIG. 3 is a drawing for explaining a management system for supporting autonomous driving of a mobile robot according to an embodiment.

FIG. 3 illustrates the management system 300 and a mobile robot 200 of which the autonomous driving is controlled through the management system 300. In some embodiments, the management system 300 may be linked with the apparatus 100 for supporting autonomous driving of a mobile robot.

Referring to FIG. 3, the apparatus 100 for supporting autonomous driving of a mobile robot may obtain the plurality of image data obtained by using the camera mounted on the mobile robot 200 and the robot pose data.

Here, the apparatus 100 for supporting autonomous driving of a mobile robot may determine the image pose data with respect to a position and orientation of the camera corresponding to each of the plurality of image data, by using the robot pose data and an external parameter of the camera.

In addition, the apparatus 100 for supporting autonomous driving of a mobile robot may determine information for the plurality of keyframes, by combining the plurality of image data and a plurality of image pose data corresponding to the plurality of image data.

Then, the apparatus 100 for supporting autonomous driving of a mobile robot may process information for the plurality of keyframes, for efficient position search of the mobile robot 200.

In more detail, the apparatus 100 for supporting autonomous driving of a mobile robot may determine the place recognition information that classifies scenes based on the visual feature, through the at least one artificial intelligence module.

In addition, the apparatus 100 for supporting autonomous driving of a mobile robot may cluster the plurality of keyframes into at least one group, based on the place recognition information. Here, the apparatus 100 for supporting autonomous driving of a mobile robot may assign the place label determined by using the place recognition information to at least one group.

Then, the apparatus 100 for supporting autonomous driving of a mobile robot may provide the plurality of candidate keyframes corresponding to the search word to the user through a user service UI, in response to receiving the search word with respect to the destination from the user.

In addition, the apparatus 100 for supporting autonomous driving of a mobile robot may receive a user's input with respect to the target keyframe associated with the destination, among the plurality of candidate keyframes, and transmit position data corresponding to the target keyframe to the mobile robot 200.

The mobile robot 200 may set autonomous driving path, with reference to position data corresponding to the target keyframe.

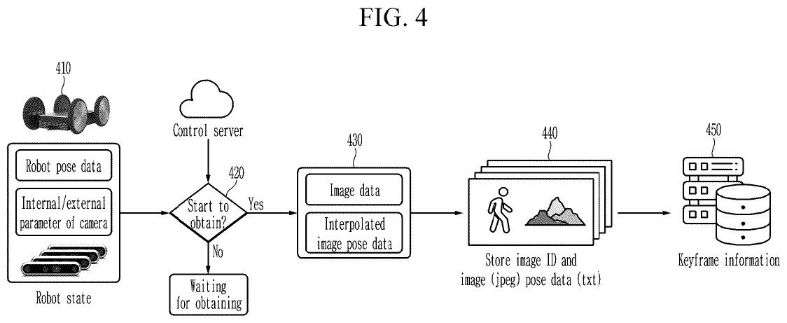

FIG. 4 is a drawing for explaining obtaining of a keyframe information according to an embodiment.

Referring to FIG. 4, when there is not an image gallery update request of the control server, the mobile robot may be in a standby state for obtaining data. The mobile robot has the robot pose data and data related to internal/external parameters of the camera, at step 410.

When there exists the image gallery update request of the control server, the apparatus 100 for supporting autonomous driving of a mobile robot may obtain the plurality of image data obtained during driving of the mobile robot, the robot pose data, and data with respect to the internal/external parameter of the camera, at step 420.

The apparatus 100 for supporting autonomous driving of a mobile robot may synchronize the plurality of image data and the robot pose data corresponding to the plurality of image data, and may determine interpolated image pose data based on the conversion on the camera parameter, at step 430.

The apparatus 100 for supporting autonomous driving of a mobile robot may store the plurality of image data, a plurality of robot pose data and the plurality of image pose data in the image gallery, at step 440.

The apparatus 100 for supporting autonomous driving of a mobile robot may generate the plurality of keyframes by using the plurality of image data and the plurality of image pose data corresponding to the plurality of image data, at step 450.

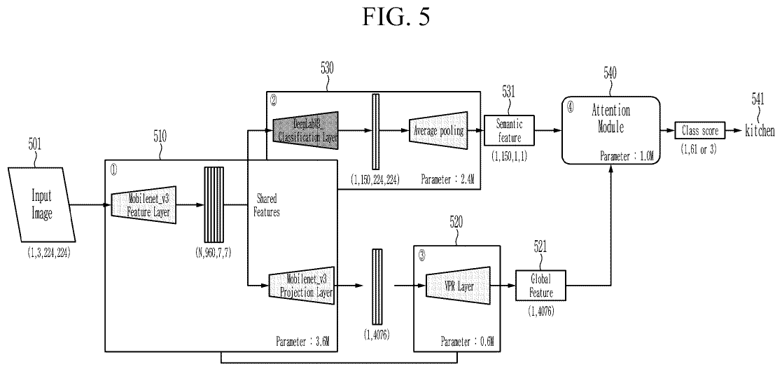

FIG. 5 is a drawing for explaining determining of the place recognition information that identifies a space with respect to image data by using the at least one artificial intelligence module according to an embodiment.

Referring to FIG. 5, the apparatus 100 for supporting autonomous driving of a mobile robot may extract a shared feature vector 511 by inputting the plurality of image data into a lightweight shared feature extractor 510.

The lightweight shared feature extractor 510 may be implemented by using a MobileNet_v3 Feature Layer, which is a lightweight convolutional neural network structure configured in consideration of computing efficiency, and the weight value of the MobileNet_v3 Feature Layer may be fixed.

In addition, the apparatus 100 for supporting autonomous driving of a mobile robot may extract a place feature vector 521 by inputting the shared feature vector 511 into a place recognition module 520.

The place recognition module 520 may be implemented by using the pre-trained multi head transformer encoder (e.g., a visual place recognition model layer).

In addition, the apparatus 100 for supporting autonomous driving of a mobile robot may extract a semantic feature vector 531 by inputting the shared feature vector 511 into a semantic segmentation module 530.

The semantic segmentation module 530 may be implemented by using a DeepLaV3_Classification Layer and Average pooling layer.

In addition, the apparatus 100 for supporting autonomous driving of a mobile robot may determine the place recognition information 541 including the class (i.e., kitchen) with respect to the place, with reference to the class score calculated by inputting the place feature vector 521 and the semantic feature vector 531 into an attention module 540.

As such, in the present disclosure, instead of directly using a foundation model or a single model as is, modules that fit the purpose are selected from a plurality of modules constituting that model and extracted and combined in the lightweight form, and thereby the autonomous driving of the mobile robot may be effectively supported even for low-spec mobile robots with limited computing resources.

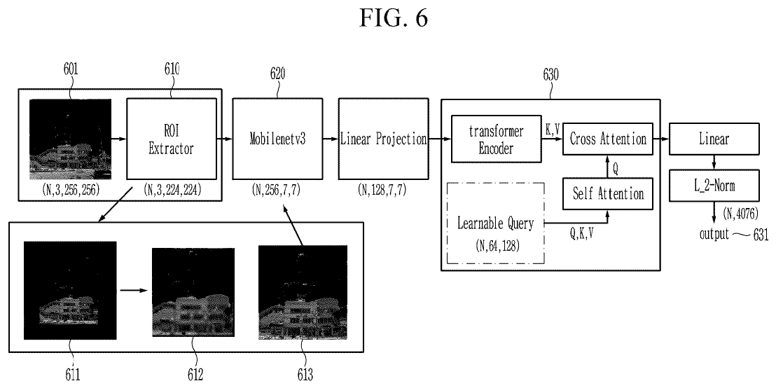

FIG. 6 is a drawing for explaining extracting of the place feature vector by using the lightweight shared feature extractor and the place recognition module according to an embodiment.

Referring to FIG. 6, the apparatus 100 for supporting autonomous driving of a mobile robot may generate a crop image 611 for which preprocessing with respect to the region of interest is performed, by inputting an image 601 into a ROI extractor 610.

The apparatus 100 for supporting autonomous driving of a mobile robot may generate an enlarged image 612, by performing a resizing preprocessing for inputting the crop image 611 into a shared feature extractor 620. In the resize processing process, a pixel damage may occur in the enlarged image 612.

The apparatus 100 for supporting autonomous driving of a mobile robot may generate a restored image 613, by performing restoration preprocessing through bilinear interpolation with respect to the enlarged image 612.

The apparatus 100 for supporting autonomous driving of a mobile robot may extract the shared feature vector by inputting the restored image 613 into the shared feature extractor 620.

The apparatus 100 for supporting autonomous driving of a mobile robot may output results of performing self-attention and intersection attention by inputting the shared feature vector into a place recognition module 630, and extract the place feature vector 631 by passing the result through a linear layer and an L2-Norm layer.

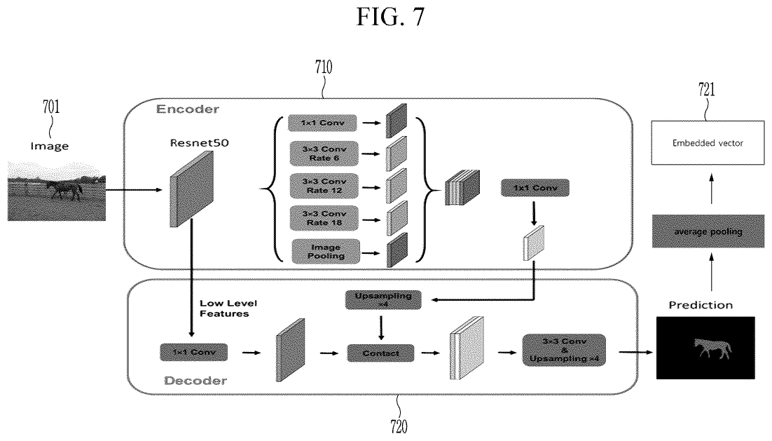

FIG. 7 is a drawing for explaining extracting of the semantic feature vector by using the lightweight shared feature extractor and the semantic segmentation module according to an embodiment.

Referring to FIG. 7, the apparatus 100 for supporting autonomous driving of a mobile robot may extract the shared feature vector by inputting an image 701 into a lightweight shared feature extractor 710.

The apparatus 100 for supporting autonomous driving of a mobile robot may input the shared feature vector into a semantic segmentation module 720, to output a prediction result with respect to the class of objects with respect to each pixel within the image 701.

The apparatus 100 for supporting autonomous driving of a mobile robot may extract a one-dimensional semantic feature vector by pass the prediction result with respect to the class of objects through an average pooling layer.

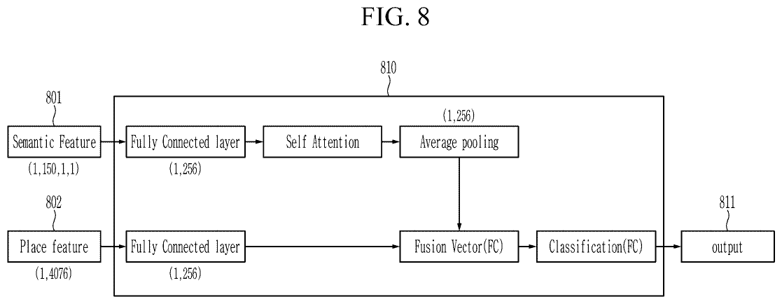

FIG. 8 is a drawing for explaining determining of the place recognition information by inputting the place feature vector and the semantic feature vector according to an embodiment into the attention module.

Referring to FIG. 8, the apparatus 100 for supporting autonomous driving of a mobile robot may determine the place recognition information 811, by inputting a semantic feature vector 801 and a place feature vector 802 into an attention module 810.

In more detail, the apparatus 100 for supporting autonomous driving of a mobile robot may input the semantic feature vector 801 and the place feature vector 802 into a fully-connected layer, to match the dimensions of the semantic feature vector 801 and the place feature vector 802.

In addition, the apparatus 100 for supporting autonomous driving of a mobile robot may determine the semantic feature vector reflecting the mutual relationship between a plurality of objects, by performing self-attention with respect to the semantic feature vector 801.

In addition, the apparatus 100 for supporting autonomous driving of a mobile robot may determine the fused feature vector by inputting the semantic feature vector and the place feature vector 802 reflecting the mutual relationship between the plurality of objects into the fusion fully-connected layer.

In addition, the apparatus 100 for supporting autonomous driving of a mobile robot may determine the place recognition information 811 including the class with respect to the place, with reference to the probability or score calculated by inputting the fused feature vector into the classification layer.

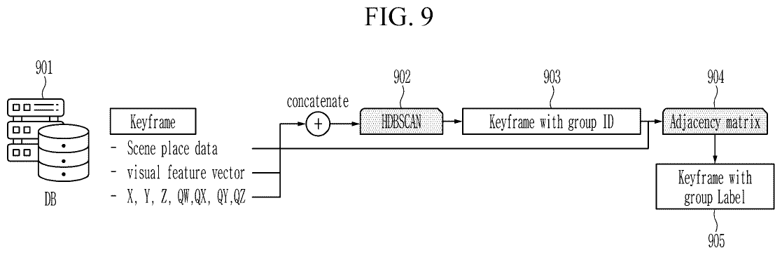

FIG. 9 is a drawing for explaining clustering of the plurality of keyframes into at least one group, based on a similarity between the plurality of keyframe vectors according to an embodiment.

Referring to FIG. 9, the apparatus 100 for supporting autonomous driving of a mobile robot may determine the plurality of keyframe vectors by fusing the place feature vector corresponding to each of the plurality of image data and the image pose data corresponding to each of the plurality of image data, at step 901.

The apparatus 100 for supporting autonomous driving of a mobile robot may cluster the plurality of keyframes into at least one group, by hierarchically analyzing the relationship between the plurality of keyframes having different densities by using a HDBSCAN algorithm, at steps 902 and 903.

The apparatus 100 for supporting autonomous driving of a mobile robot may designate the class that the plurality of keyframes commonly include as the place label, with reference to a similarity between the plurality of keyframe vectors, and may assign it to at least one clustered group, at steps 904 and 905.

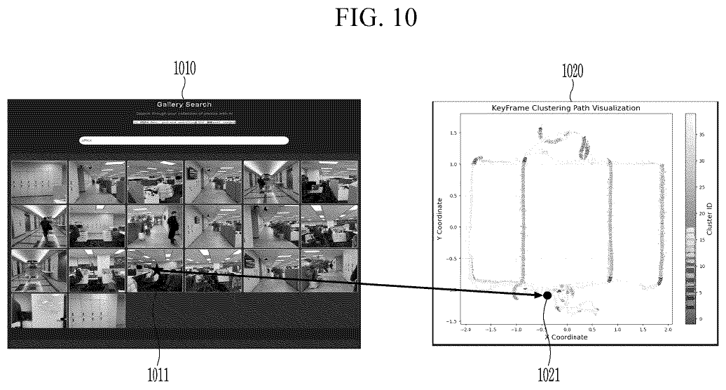

FIG. 10 is a drawing for explaining providing of position information corresponding to the target keyframe to the mobile robot based on a user's input with respect to the web-based user interface that displays the plurality of candidate keyframes according to an embodiment.

FIG. 10 illustrates the web-based user interface 1010 displaying the plurality of candidate keyframes and the POI system interface 1020 visualizing an autonomous driving path corresponding to the destination.

Referring to FIG. 10, the apparatus 100 for supporting autonomous driving of a mobile robot may provide the web-based user interface 1010 that displays the plurality of candidate keyframes, in response to receiving the search word with respect to the destination from the user.

When receiving a user's input with respect to a target keyframe 1011 associated with the destination, among the plurality of candidate keyframes, the apparatus 100 for supporting autonomous driving of a mobile robot may provide position information 1021 corresponding to the target keyframe 1011 to the mobile robot.

The mobile robot can plan a path according to the position corresponding to the user's input, by mapping the position information 1021 and the target keyframe 1011 by using the POI system.

FIG. 11 is a drawing for explaining a computing device according to an embodiment.

Referring to FIG. 11, a method and apparatus for supporting autonomous driving of a mobile robot according to embodiments may be implemented by using the computing device 50. The computing device 50 may be implemented as various forms of electronic devices, servers, or similar devices, and its function may be implemented through a combination of software and hardware.

The computing device 50 may include at least one of the processors 910, a memory 930, a user interface input device 940, a user interface output device 950, and a storage device 960 that communicate through a bus 920. The computing device 50 may also include a network interface 970 electrically connected to a network 40. The network interface 970 may transmit or receive signals with other entities through the network 40.

The processor 910 may be implemented as various types of computational devices, for example, a micro controller unit (MCU), an application processor (AP), a central processing unit (CPU), a graphics processing unit (GPU), a neural processing unit (NPU), a quantum processing unit (QPU), or the like. The processor 910 is a semiconductor device that executes instructions stored in the memory 930 or the storage device 960, and may play a core role of the system. The program codes and data stored in the memory 930 or the storage device 960 may command the processor 910 to perform a specific work, thereby enabling the overall operation of the system. Through this, the processor 910 may be configured to implement various functions and methods described with reference to FIG. 1 to FIG. 2.

The memory 930 and the storage device 960 may include various types of volatile or non-volatile storage media, for storing and accessing data of the system. For example, the memory 930 may include a read-only memory (ROM) 931 and a random-access memory (RAM) 932. In some embodiments, the memory 930 may be embedded inside the processor 910, and in this case, the data transmission speed between the memory 930 and the processor 910 may be very fast. In some other embodiment, the memory 930 may be located outside the processor 910, and in this case, the memory 930 may be connected to the processor 910 through various data buses or interfaces. This connection may be made through already known various means, for example, a Peripheral Component Interconnect Express (PCIe) interface for high-rate data transmission or a memory controller.

In some embodiments, at least some components or features of a method and apparatus for supporting autonomous driving of a mobile robot according to embodiments may be implemented as program or software executed by the computing device 900, and the program or software may be stored in a computer-readable medium. In more detail, the computer-readable medium according to an embodiment may record a program for executing steps included in a method and apparatus for supporting autonomous driving of a mobile robot according to embodiments implementation, on a computer including the processor 910 executing program or instruction stored in the memory 930 or the storage device 960.

In some embodiments, at least some components and features of a method for controlling an external power supply and apparatus according to embodiments may be implemented by using hardware or circuit of the computing device 50, or may be implemented as a separate hardware or circuitry that may be electrically connected to the computing device 50.

In some embodiments, one or more non-transitory computer-readable media that include an instruction executable by the computing device 50 may be provided, and the instruction may cause the computing device 50 to perform the operation, when executed by one or more processors of the computing device 50. Here, the operation may include components, features, steps, or the like described in this specification with respect to a method and apparatus for supporting autonomous driving of a mobile robot according to embodiments.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of appended claims.

What is claimed is:

1. A method for supporting autonomous driving of a robot, the method comprising:
generating, by a processor of a computing device, information for a plurality of keyframes, based on a plurality of image data obtained by using a camera mounted on the robot and robot pose data with respect to a position and orientation of the robot corresponding to each of the plurality of image data;
determining, by the processor using at least one artificial intelligence module, place recognition information that identify a space with respect to each of the plurality of image data; and
managing, by the processor, an image gallery for supporting the autonomous driving of the robot by clustering, based on the place recognition information, the plurality of keyframes into at least one group.

2. The method of claim 1, wherein generating the information for the plurality of keyframes comprises
estimating, by the processor, the robot pose data of each time point at which the plurality of image data are obtained, by using linear interpolation for compensating, differences between time points at which the plurality of image data are obtained and a time point at which the robot pose data is obtained.

3. The method of claim 1, wherein generating the information for the plurality of keyframes comprises:
determining, by the processor using the robot pose data and an external parameter of the camera, image pose data with respect to the position and orientation of the camera corresponding to each of the plurality of image data; and
generating, by the processor using the plurality of image data and the image pose data, the information for the plurality of keyframes.

4. The method of claim 1, wherein determining the place recognition information comprises
extracting, by the processor using a lightweight shared feature extractor, a shared feature vector from each of the plurality of image data.

5. The method of claim 4, wherein determining the place recognition information comprises:
extracting, by the processor by inputting the shared feature vector into a place recognition module, a place feature vector with respect to a space comprised in each of the plurality of image data; and
extracting, by the processor by inputting the shared feature vector into a semantic segmentation module, a semantic feature vector with respect to an object comprised in each of the plurality of image data.

6. The method of claim 5, wherein determining the place recognition information comprises:
determining, by the processor by inputting the place feature vector and the semantic feature vector into an attention module, a fused feature vector with respect to the place feature vector and the semantic feature vector; and
determining, by the processor, the place recognition information from the fused feature vector.

7. The method of claim 1, wherein managing the image gallery comprises:
determining, by the processor, a plurality of keyframe vectors by fusing a place feature vector corresponding to each of the plurality of image data and image pose data corresponding to each of the plurality of image data; and
clustering, by the processor, based on a similarity between the plurality of keyframe vectors, the plurality of keyframes into the at least one group.

8. The method of claim 7, wherein clustering the plurality of keyframes into the at least one group further comprises
assigning, by the processor using the place recognition information, a place label.

9. The method of claim 1, further comprising:
in response to receiving a search word from a user with respect to a destination, providing, by the processor, a plurality of candidate keyframes corresponding to the search word in the image gallery to the user; and
in response to a selection by the user, providing, by the processor, position information to the robot corresponding to a target keyframe of the plurality of candidate keyframes.

10. The method of claim 9, wherein providing the plurality of candidate keyframes to the user comprises
providing, by the processor, a web-based user interface that displays the plurality of candidate keyframes for each of group.

11. An apparatus for supporting autonomous driving of a robot, the apparatus comprising:
one or more non-transitory computer-readable media with instructions stored thereon; and
one or more processors configured to execute the instructions by
generating information for a plurality of keyframes, based on a plurality of image data obtained by using a camera mounted on the robot and robot pose data with respect to a position and orientation of the robot corresponding to each of the plurality of image data;
determining, by using at least one artificial intelligence module, place recognition information that identify a space with respect to each of the plurality of image data; and
managing, by clustering the plurality of keyframes into at least one group, based on the place recognition information, an image gallery for supporting the autonomous driving of the robot.

12. The apparatus of claim 11, wherein generating the information for the plurality of keyframes comprises
estimating the robot pose data of each time point at which the plurality of image data are obtained, by using linear interpolation for compensating, differences between time points at which the plurality of image data are obtained and a time point at which the robot pose data is obtained.

13. The apparatus of claim 11, wherein generating the information for the plurality of keyframes comprises:
determining, by using the robot pose data and an external parameter of the camera, image pose data with respect to the position and orientation of the camera corresponding to each of the plurality of image data; and
generating, by using the plurality of image data and the image pose data, the information for the plurality of keyframes.

14. The apparatus of claim 11, wherein determining the place recognition information comprises
extracting, by using a lightweight shared feature extractor, a shared feature vector from each of the plurality of image data.

15. The apparatus of claim 14, wherein determining the place recognition information comprises:
extracting, by inputting the shared feature vector into a place recognition module, a place feature vector with respect to a space comprised in each of the plurality of image data; and
extracting, by inputting the shared feature vector into a semantic segmentation module, a semantic feature vector with respect to an object comprised in each of the plurality of image data.

16. The apparatus of claim 15, wherein determining the place recognition information comprises:
determining, by inputting the place feature vector and the semantic feature vector into an attention module, a fused feature vector with respect to the place feature vector and the semantic feature vector; and
determining the place recognition information from the fused feature vector.

17. The apparatus of claim 11, wherein managing the image gallery comprises:
determining a plurality of keyframe vectors by fusing a place feature vector corresponding to each of the plurality of image data and image pose data corresponding to each of the plurality of image data; and
clustering, based on a similarity between the plurality of keyframe vectors, the plurality of keyframes into the at least one group.

18. The apparatus of claim 17, wherein clustering the plurality of keyframes into the at least one group further comprises
assigning a place label determined by using the place recognition information to the at least one group.

19. The apparatus of claim 11, wherein the instructions further comprise:
in response to receiving a search word for a destination from a user, providing a plurality of candidate keyframes corresponding to the search word in the image gallery to the user; and
based on a selection of the user, providing position information corresponding to a target keyframe of the plurality of candidate keyframes to the robot.

20. A non-transitory computer-readable medium comprising an instructions executable by a computing device, wherein the instructions cause the computing device to:
generate information for a plurality of keyframes, based on a plurality of image data obtained by using a camera mounted on a robot and robot pose data with respect to position and orientation of the robot corresponding to each of the plurality of image data;
determine, by using at least one artificial intelligence module, place recognition information that identify a space with respect to each of the plurality of image data; and
manage, by clustering, based on the place recognition information, the plurality of keyframes into at least one group, an image gallery for supporting autonomous driving of the robot.
